(19) United States
(12) Patent Application Publication
(10) Pub. No.: US 2021/0217326 A1
(43) Pub. Date: Jul. 15, 2021

(54) CHARACTER OUTPUT DEVICE

(71) Applicant: DENTSU INC., Tokyo (JP)

(72) Inventor: Kosuke TAKAHASHI, Tokyo (JP)

(73) Assignee: DENTSU INC., Tokyo (JP)

(21) Appl. No.: 17/058,930

(22) PCT Filed: May 17, 2019
(86) PCT No.: PCT/JP2019/019599

§ 371 Date: Nov. 25, 2020

(30) Foreign Application Priority Data
Jul. 27, 2018 (JP) 2018-140939

(51) Int. Cl. G09B 21/02; G06F 3/12; B41J 3/32

(52) U.S. Cl. CPC G09B 21/02; B41J 3/32; G06F 3/1237; G06F 3/1208

(57) ABSTRACT

A character output device with which reading of print characters is not hindered by Braille characters even when Braille characters are output over print characters is provided. A character output device (1) includes a storage unit (2) that stores font data made up of a print character layer and a Braille character layer, a print character printing unit (3) that prints print characters onto a medium for output based on the print character layer, and a Braille character output unit (4) that outputs Braille characters onto the medium on which the print characters have been printed, based on the Braille character layer. Characters included in the font data are configured so that every dot portion (P) that forms a Braille character overlies a line portion (L) that forms a print character. When outputting the Braille characters onto the medium on which the print characters have been printed, the Braille character output unit (4) makes registration such that every dot portion (P) that forms a Braille character overlies a line portion (L) that forms a print character.

### TECHNICAL FIELD

The present invention relates to a character output device for outputting Braille characters over print characters.

### BACKGROUND ART

There have been known methods of arranging Braille characters recognizable by visually impaired people and print characters visually recognizable by sighted people having no visual impairments such that they are vertically aligned. However, such a method of arranging Braille characters and print characters in vertical alignment requires a separate space for arranging Braille characters to be reserved above or below a space for arranging print characters. As a result, it is sometimes difficult to reserve a space for arranging Braille characters such as when an arrangement space is limited. Accordingly, there has been a proposal of a method of outputting Braille characters over print characters (see Patent Literature 1, for example).

Such a conventional method does not require a space for Braille characters to be reserved separately from a space for print characters because Braille characters can be output over print characters. However, in the conventional method, only some of the dot portions that form a Braille character overlie line portions that form a print character. That is, dot portions forming a Braille character are also located in portions other than the line portions forming a print character. This leads to the problem of reading of a print character being hindered by dot portions that are located in portions other than the line portions of the print character (portions that should be blank).

### CITATION LIST

### Patent Literature

Patent Literature 1: Japanese Patent Laid-Open No. 2006-53312

### SUMMARY OF INVENTION

### Technical Problem

The present invention has been made against such a background. An object of the present invention is to provide a character output device with which reading of print characters is not hindered by Braille characters even when Braille characters are output over print characters.

### Solution to Problem

An aspect of the present invention is a character output device, which includes: a storage unit that stores font data made up of a print character layer and a Braille character layer; a print character printing unit that prints print characters onto a medium for output based on the print character layer; and a Braille character output unit that outputs Braille characters onto the medium on which the print characters have been printed, based on the Braille character layer. Characters included in the font data are configured so that every dot portion that forms a Braille character overlies a line portion that forms a print character, and when outputting the Braille characters onto the medium on which the print characters have been printed, the Braille character output unit makes registration such that every dot portion that forms the Braille characters overlies a line portion that forms the print characters.

As described below, the present invention has other aspects. Thus, the disclosure of the present invention is intended to provide some of the aspects of the present invention and does not mean to limit the scope of the invention set forth and claimed herein.

### BRIEF DESCRIPTION OF DRAWINGS

FIG. 1 is a block diagram showing a configuration of a character output device in an embodiment of the present invention.

FIG. 2 shows an example of font data in an embodiment of the present invention.

FIG. 3 shows another example of font data in an embodiment of the present invention.

FIG. 4 shows yet another example of font data in an embodiment of the present invention.

FIG. 5 is a flow diagram for describing operations of the character output device in an embodiment of the present invention.

### DESCRIPTION OF EMBODIMENTS

The present invention is described in detail below. However, the detailed description that follows and the accompanying drawings are not intended to limit the invention.

A character output device according to the present invention includes a storage unit that stores font data made up of a print character layer and a Braille character layer, a print character printing unit that prints print characters onto a medium for output based on the print character layer, and a Braille character output unit that outputs Braille characters onto the medium on which the print characters have been printed, based on the Braille character layer. Characters included in the font data are configured so that every dot portion that forms a Braille character overlies a line portion that forms a print character, and when outputting the Braille characters onto the medium on which the print characters have been printed, the Braille character output unit makes registration such that every dot portion that forms the Braille characters overlies a line portion that forms the print characters.

Since this configuration allows Braille characters to be output over print characters, it does not require a space for Braille characters to be reserved separately from a space for print characters. Moreover, in this case, every dot portion that forms a Braille character overlies a line portion that forms a print character, so reading of print characters is not hindered by Braille characters even when Braille characters are output over print characters.

In the character output device of the present invention, the Braille character output unit may use UV printing to output the Braille characters onto the medium on which the print characters have been printed.

This configuration allows Braille characters to be output over print characters by means of UV printing.

In the character output device of the present invention, the Braille character output unit may also use silk screen printing to output the Braille characters onto the medium on which the print characters have been printed.

This configuration allows Braille characters to be output over print characters by means of silk screen printing.

In the character output device of the present invention, the Braille character output unit may also use embossing to output the Braille characters onto the medium on which the print characters have been printed.

This configuration allows Braille characters to be output over print characters by means of embossing.

In the character output device of the present invention, the Braille character output unit may also use inscription to output the Braille characters onto the medium on which the print characters have been printed.

This configuration allows Braille characters to be output over print characters by means of inscription.

In accordance with the present invention, reading of print characters is not hindered by Braille characters even when Braille characters are output over print characters.

In the following, a character output device according to an embodiment of the present invention is described with the drawings. This embodiment illustrates the case of a character output device used for production of books, tapes, guide boards, tickets, etc. that can be shared by visually impaired people and sighted people.

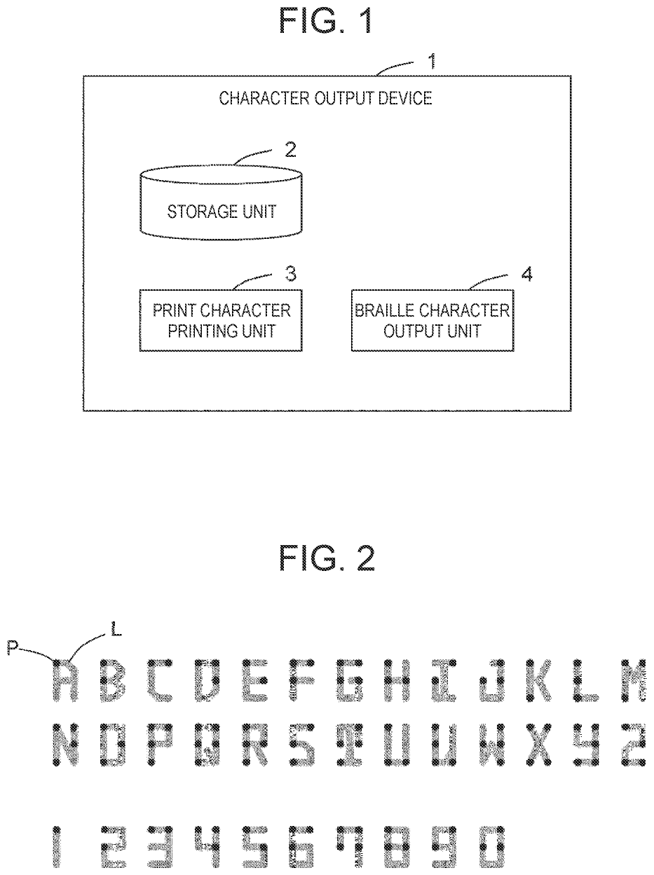

The configuration of the character output device according to an embodiment of the present invention is described with reference to drawings. FIG. 1 is a block diagram showing a configuration of the character output device according to this embodiment. As shown in FIG. 1, the character output device includes a storage unit that stores font data made up of a print character layer and a Braille character layer, a print character printing unit that prints print characters onto a medium for output (e.g., a book, a tape, a guide board, a ticket, etc.) based on the print character layer, and a Braille character output unit that outputs Braille characters onto the medium on which the print characters have been printed, based on the Braille character layer.

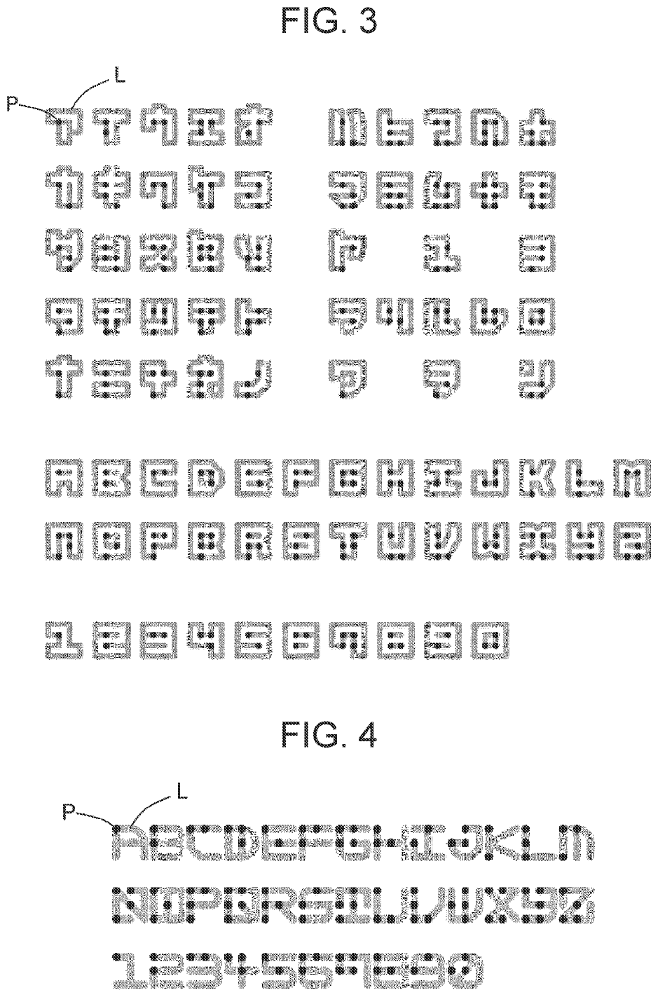

FIG. 2 shows an example of the font data. FIG. 3 shows another example of the font data. FIG. 4 shows yet another example of the font data. As shown in FIGS. 2 to 4, the characters included in the font data are configured so that every dot portion P that forms a Braille character overlies a line portion L that forms a print character.

Then, when outputting Braille characters onto the medium on which the print characters have been printed, the Braille character output unit makes registration such that every dot portion P that forms a Braille character overlies a line portion L that forms a print character. For the registration, a known technique can be used. For example, reference points are set on print characters as well as on Braille characters, and registration is made so that the reference points on the print characters coincide with the reference points on the Braille characters.

In this embodiment, the Braille character output unit uses UV printing to output Braille characters onto the medium on which print characters have been printed. Here, a sufficient thickness of the dot portions P of Braille characters may not be obtained in a single run of UV printing. In such a case, a sufficient thickness can be obtained by repeating UV printing multiple times (e.g., 10 times).

The Braille character output unit may also use silk screen printing to output Braille characters onto the medium on which print characters have been printed. Alternatively, the Braille character output unit may use embossing to output Braille characters onto the medium on which print characters have been printed. The Braille character output unit may also use inscription to output Braille characters onto a medium on which print characters have been printed.

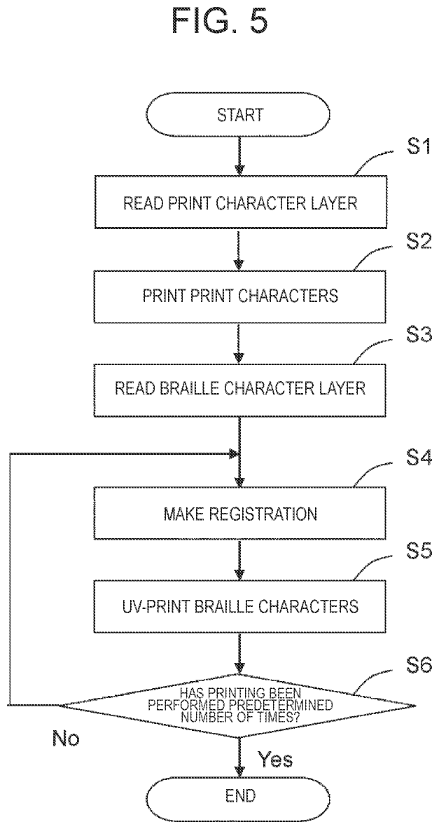

The character output device configured as described above is now described for its operation with reference to the flow diagram of FIG. 5.

As shown in FIG. 5, in order to output print characters and Braille characters with the character output device according to this embodiment, first, data on the print character layer is read from the storage unit (S1), and print characters are printed onto the medium for output by the print character printing unit (S2). When the printing of the print characters is complete, data on the Braille character layer is then read from the storage unit (S3), and UV printing of Braille characters is performed by the Braille character output unit.

Here, registration is made first so that every dot portion P that forms a Braille character overlies a line portion L that forms a print character (S4), after which Braille characters are UV-printed onto the medium on which the print characters have been printed (S5). After the UV printing of the Braille characters is repeated a predetermined number of times (e.g., 10 times) (S6), the process ends.

Since the character output device according to this embodiment shown above can output Braille characters over print characters, it does not require a space for Braille characters to be reserved separately from a space for print characters. Moreover, in this case, every dot portion P that forms a Braille character overlies a line portion L that forms a print character, so reading of print characters is not hindered by Braille characters even when Braille characters are output over print characters. Thus, books, tapes, guide boards, tickets, etc. that are produced with this character output device can be equally utilized (shared) by visually impaired people and sighted people

In this embodiment, Braille characters can be output over print characters by means of UV printing, for example. Braille characters can also be output over print characters by means of silk screen printing. Alternatively, Braille characters can be output over print characters by means of embossing. Further, Braille characters can be output over print characters by means of inscription.

Embodiments of the present invention have been described above by way of illustration, the scope of the present invention is not limited thereto and modifications and variation can be made within the scope set forth in the claims according to an objective.

While preferred embodiments of the present invention that are presently conceivable are described above, it is understood that different variations can be made to the embodiments and it is intended that all such variations falling within the true spirit and scope of the present invention are encompassed by the attached claims.

### INDUSTRIAL APPLICABILITY

As described above, the character output device according to the present invention has the effect of reading of print characters being not hindered by Braille characters even when Braille characters are output over print characters, and can be advantageously used for production of books, tapes, guide boards, tickets, etc. that can be shared by visually impaired people and sighted people.

### REFERENCE SIGNS LIST

1 character output device

2 storage unit

3 print character printing unit

4 Braille character output unit

P dot portion

L line portion

1. A character output device comprising:
a storage unit that stores font data made up of a print character layer and a Braille character layer;
a print character printing unit that prints print characters onto a medium for output based on the print character layer; and
a Braille character output unit that outputs Braille characters onto the medium on which the print characters have been printed, based on the Braille character layer,
wherein characters included in the font data are configured so that every dot portion that forms a Braille character overlies a line portion that forms a print character, and
wherein when outputting the Braille characters onto the medium on which the print characters have been printed, the Braille character output unit makes registration such that every dot portion that forms the Braille characters overlies a line portion that forms the print characters.

2. The character output device according to claim 1, wherein the Braille character output unit uses UV printing to output the Braille characters onto the medium on which the print characters have been printed.

3. The character output device according to claim 1, wherein the Braille character output unit uses silk screen printing to output the Braille characters onto the medium on which the print characters have been printed.

4. The character output device according to claim 1, wherein the Braille character output unit uses embossing to output the Braille characters onto the medium on which the print characters have been printed.

5. The character output device according to claim 1, wherein the Braille character output unit uses inscription to output the Braille characters onto the medium on which the print characters have been printed.
